(19) United States
(12) Patent Application Publication
(10) Pub. No.: US 2026/0259336 A1
(43) Pub. Date: Sep. 3, 2026

(54) METHOD AND APPARATUS FOR REGULATING UNDERWATER SEISMIC SOURCE PRESSURE

(71) Applicant: SERCEL, INC., Houston, TX (US)

(72) Inventors: Paul WENTZLER, Houston, TX (US); Maxime BENANIBA, Massy Cedex (FR); Jérémy AZNAR, Massy Cedex (FR); Robert FOERTSCH, Houston, TX (US)

(21) Appl. No.: 19/206,363

(22) Filed: May 13, 2025

Related U.S. Application Data
(60) Provisional application No. 63/764,835, filed on Feb. 28, 2025.
(60) Provisional application No. 63/764,855, filed on Feb. 28, 2025.

(51) Int. Cl. G01V 1/133; G05D 16/10

(52) U.S. Cl. CPC G01V 1/133; G05D 16/107

(57) ABSTRACT

A pressure regulator for controlling a pressure supplied by an umbilical to a seismic source includes a frame configured to be located downstream from the umbilical and upstream from the seismic source; a dome piston valve supported by the frame and configured to receive compressed air with an input pressure Pin and to output compressed air with an output pressure Pout, smaller than the input pressure Pin; a pilot valve supported by the frame and configured to control the output pressure Pout; and wherein the pilot valve and the dome piston valve are configured to prevent a release of the compressed air into the ambient.

### BACKGROUND

### Technical Field

Embodiments of the subject matter disclosed herein generally relate to an apparatus and associated method for controlling an input pressure to an underwater seismic source, and more specifically, to reducing an input pressure to an underwater air gun that is configured to generate seismic waves for surveying a subsurface.

### Discussion of the Background

The subsurface (i.e., the volume of earth under the ocean bottom) has a structure that includes underground formations, which are often explored using reflection and/or refraction seismology. Geotechnical mitigation surveys might help in understanding some formations, e.g., boulders. Some underground formations, e.g., faults, are associated with a resource reservoir (for example, oil and gas, but other resources are of interest, for example, rare metals, etc.). Alternatively, the underground formations might be considered as opportunities for storing some compounds, like e.g. for carbon storage (CCUS). In reflection and/or refraction seismology, a seismic source emits signals (which can be expressed as overlapping seismic waves) directed at the explored formation. Reflections and/or refractions of the signals arrive at different time intervals, after the signal emissions, at receivers. The reflections and/or refractions occur at interfaces between the explored formation's layers because signal propagation speed changes at these interfaces. The reflections and/or refractions carry information allowing estimation of depths of the interfaces and the nature of the layers. An image of the underground formation generated using this information may suggest the presence of subterranean resource deposits. Reflection and/or refraction seismology is used on land and in marine environments.

A conventional marine survey system 100 for generating seismic signals and recording their reflections and/or refractions off a formation under the seafloor is illustrated in FIG. 1. A vessel 110 tows an array of seismic receivers 111 provided on streamers 112 (only two shown for simplicity). The streamers may be towed so that the receivers are at a substantially constant depth relative to a surface 114 of the water. However, the streamers may alternatively be towed so that receivers 111 on a same streamer 112 are at different depths from the surface 114.

Vessel 110 also tows a seismic source 116 configured to generate seismic signals directed at the explored formation. The seismic source 116 is towed with an umbilical 117 that is directly connected to the seismic source 116. The signals emitted by the seismic source 116 propagate along various trajectories 118 (only one labeled). Since the seismic signals are directed toward the explored formation, their energy propagates preferably downward, toward the seafloor 120. The seismic signals penetrate the seafloor 120 into the explored formation, being reflected and/or refracted, for example, at an interface 122. The reflected/refracted signals propagate upward, along trajectories such as 124, and are detected by the receivers 111 on the streamers 112. Analysis of the data (e.g., arrival time and amplitude of the reflected signals) collected by the receivers 111 may yield an image of the formation under the seafloor.

The marine survey systems include conventional sources (e.g., airguns) that need to be filled with compressed air prior to being fired. The towing vessel 110 carries a source of compressed air (not shown) that pumps the compressed air into each airgun forming the seismic source. However, with the development and deployment of new seismic sources, that require a larger amount of compressed air in a same amount of time as the conventional seismic sources, it is becoming more challenging to provide the necessary amount of compressed air. To address this problem, the existing seismic surveys rely on larger diameter and shorter lengths umbilicals. The umbilical is the part that electrically and pneumatically connects the seismic source to the vessel.

However, having one type of umbilical for these large volume seismic sources and another type of umbilical for the conventional sources is neither economical nor practical. In addition, using a mixture of short and long umbilicals creates logistical problems in terms of towing plural seismic sources at the same distance relative to the vessel, along the inline direction.

Accordingly, it is desirable to be able to use a single type of umbilical, preferably the conventional one, no matter what type of seismic source is towed by the vessel.

### SUMMARY

According to an embodiment, there is a pressure regulator for controlling a pressure supplied by an umbilical to a seismic source, and the pressure regulator includes a frame configured to be located downstream from the umbilical and upstream from the seismic source, a dome piston valve supported by the frame and configured to receive compressed air with an input pressure Pin and to output compressed air with an output pressure Pout, smaller than the input pressure Pin, and a pilot valve supported by the frame and configured to control the output pressure Pout. The pilot valve and the dome piston valve are configured to prevent a release of the compressed air into the ambient.

According to another embodiment, there is a seismic survey system for generating seismic data underwater and the system includes a first umbilical configured to be connected with a first end to a manifold on a vessel and with a second end to a pressure regulator, the pressure regulator configured to be connected downstream from the first umbilical and upstream from a first seismic source, the pressure regulator being configured to receive compressed air having an input pressure Pin and to output compressed air having an output pressure Pout, smaller than the input pressure Pin, and the first seismic source configured to generate seismic waves underwater.

According to yet another embodiment, there is a method for generating seismic data with a first marine seismic source, and the method includes connecting a pressure regulator between a first umbilical and the first seismic source, deploying the first umbilical, pressure regulator, and the first seismic source in water, supplying compressed air having an input pressure (Pin), through the first umbilical, to the pressure regulator, supplying compressed air having an output pressure (Pout), smaller than the input pressure (Pin), from the pressure regulator to the first seismic source, and firing the first seismic source to discharge the compressed air having the output pressure (Pout) into the water.

### BRIEF DESCRIPTION OF THE DRAWINGS

The accompanying drawings, which are incorporated in and constitute a part of the specification, illustrate one or more embodiments and, together with the description, explain these embodiments. In the drawings:

FIG. 1 illustrates a conventional marine survey system having a vessel that tows a seismic source with an umbilical;

FIG. 2 illustrates the sound output of a conventional source and a source that has a larger volume;

FIG. 3 illustrates a seismic source that is attached to a float and to an umbilical;

FIG. 4 illustrates a seismic source that is provided with a pressure regulator downstream of the umbilical;

FIG. 5 schematically illustrates the pneumatic connections between a compressor on the towing vessel and seismic sources having pressure regulators;

FIG. 6 schematically illustrates a pressure regulator that is provided to the seismic source;

FIG. 7 illustrates in more detail the pressure regulator, its components, and the connections between the components;

FIG. 8 is a cross-section of a dome piston valve used by the pressure regulator for reducing a pressure supplied to the seismic source;

FIGS. 9A to 9C illustrate the performance of a seismic source with a pressure regulator versus a conventional source that does not include a pressure regulator;

FIG. 10 illustrates the firing and filling frequency of two arrays of a seismic source having the pressure regulator;

FIG. 11A illustrates a seismic survey acquisition system that uses conventional umbilicals and seismic sources, FIG. 11B illustrates a seismic survey acquisition system that uses an improved seismic source and a specific umbilical, and FIG. 11C illustrates a seismic survey acquisition system that uses a conventional umbilical coupled with an improved seismic source through a pressure regulator;

FIG. 12A shows a seismic survey acquisition system that uses a mixture of conventional and improved seismic sources and their corresponding umbilicals, and how the towing vessel hosts a pressure regulator for supplying an appropriate pressure to the improved seismic source;

FIG. 12B shows a seismic survey acquisition system that uses a mixture of conventional and improved seismic sources and a single type of umbilical, with a pressure regulator provided underwater, upstream the improved seismic source;

FIG. 13 shows a seismic survey acquisition system that uses plural improved seismic sources and a single type of umbilical, with pressure regulators provided underwater, upstream the improved seismic source, and with a mechanism for remotely controlling the output pressure of the pressure regulators; and

FIG. 14 is a method for firing an improved source with a conventional umbilical attached to an underwater pressure regulator.

### DETAILED DESCRIPTION

The following description of the exemplary embodiments refers to the accompanying drawings. The same reference numbers in different drawings identify the same or similar elements. The following detailed description does not limit the invention. Instead, the scope of the invention is defined by the appended claims. The following embodiments are discussed, for simplicity, relative to an improved marine source that is equipped with a pressure regulator. Similar methods and devices may be used for other marine sources that use compressed air.

Reference throughout the specification to “one embodiment” or “an embodiment” means that a particular feature, structure or characteristic described in connection with an embodiment is included in at least one embodiment of the subject matter disclosed. Thus, the appearance of the phrases “in one embodiment” or “in an embodiment” in various places throughout the specification is not necessarily referring to the same embodiment. Further, the particular features, structures or characteristics may be combined in any suitable manner in one or more embodiments.

In order to detect more energy reflected and/or refracted from an explored formation under the seafloor, and/or to protect the marine animals, there is a movement to develop seismic sources that attenuate the high frequency components of seismic signals. In this regard, seismic sources used as deep penetration sound sources produce output frequencies generally between 1 Hz to about 1200 Hz, to identify subsurface geologic layers and define the subsurface structure. A frequency between 1 and 40 Hz is considered herein to be a low frequency, a frequency between 40 and 100 Hz is considered herein to be a high frequency, and a frequency larger than 100 Hz is considered to herein to be a very high frequency. The conventional seismic sources are typically fired at compressed air pressures in the range of 2000 psi to 3000 psi. These conventional seismic sources produce an initial pulse or primary pressure pulse, typically of about 1.5 milliseconds (ms) of rise time to reach a peak pressure. This extremely fast rise time produces an abundance of very high frequency sound components in the primary pressure pulse, which are outside of the frequency range of interest and therefore may not be beneficial in the identification of subsurface geological structures.

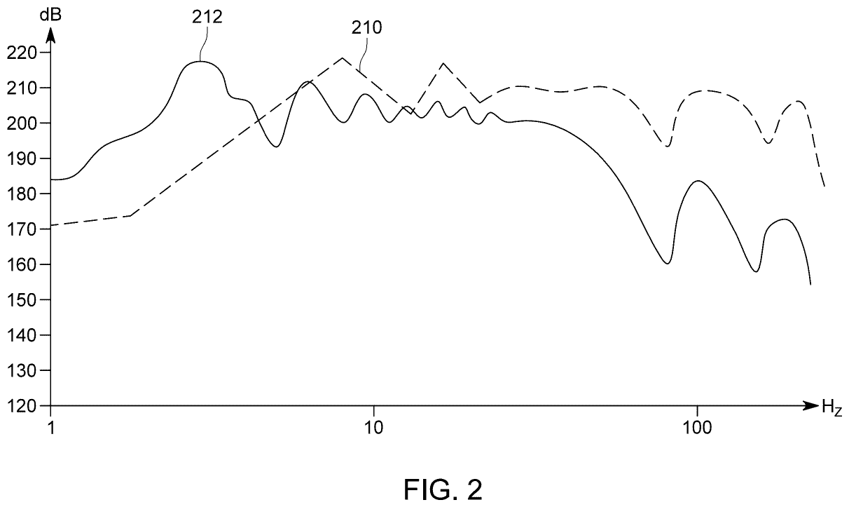

Thus, a tuned pulse source (TPS) was developed by the assignee of this application for reducing the emission of the very high frequencies. The TPS source is disclosed in U.S. Pat. No. 11,953,634, the entire enclosure of which is incorporated herein by reference. This source, differently from the conventional underwater seismic sources operates at operating pressures in the range of less than 600 psi-1200 psi and more preferably at 1000 psi. As illustrated in FIG. 2, the conventional seismic source has a sound output 210 dB with a peak of around 7 Hz while the TPS source has a sound output 212 dB with a peak around 3 Hz. The figure also shows that the very high frequencies of the TPS source are reduced when compared to the conventional source. The volume of the conventional seismic source is in the range of hundreds to thousands of in³ while the volume of the TPS source is in the range of tens of thousands of in³, for example, about 28,000 in³. This large volume difference needs to be filled with compressed air in the same time as the conventional sources. For this reason, the vessel towing the TPS source has a larger umbilical (about 1 and ¼″ instead of 1″ in diameter) and a shorter length (about 150 m versus 500 m for the conventional source).

The inventors of this application have discovered that placing a pressure regulator in the water, just downstream (after) the umbilical high pressure supply end, and upstream (before) the TPS source solve the above noted problems, i.e., a standard umbilical may be used with the TPS source without increasing the time necessary to fill the source after a shooting.

According to various embodiments discussed now, a seismic survey system may include a first source (e.g., a conventional source) towed by a vessel with a first umbilical having a first frequency output (the frequency corresponds to the sound output 210 dB in FIG. 2), and a second source (e.g., TPS source) towed by the same vessel with a second umbilical having a second frequency output (the frequency output corresponds to the sound output 212 dB in FIG. 2). The first frequency output is higher than (e.g., at least twice) the second frequency output, and the first and second umbilicals do have the same characteristics (e.g., they are identical in terms of their inside diameter size for carrying the compressed air and their length).

In one embodiment, the first source of the system has a first volume and the second source of the system has a second volume, larger than the first volume. For the same umbilicals, the volume of the second source is at least an order of magnitude (e.g., 10) larger than the volume of the first source. A seismic source in this document refers to a plurality of individual sources (or guns), which may be arranged in subarrays, with each subarray being towed by the vessel along a different inline direction relative to another subarray. This means that a seismic source extends along a crossline direction (a direction perpendicular to the inline direction), and may include 3 different subarrays, each subarray including between 6 and 12 individual sources (guns). Other numbers may be used for the number of subarrays, or for the number of individual sources per subarray.

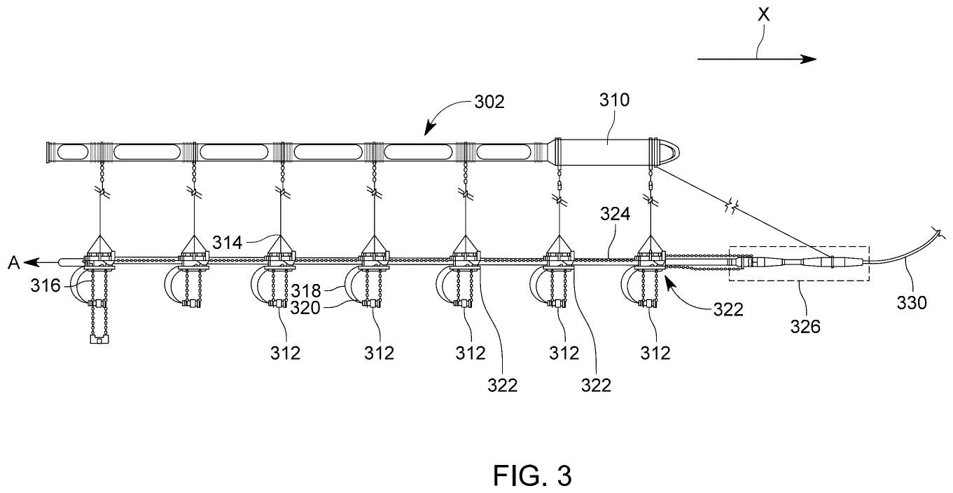

Before discussing the details of the invention, the structure of an underwater source 300 (may be a conventional source or the TPS source) is discussed. Note that the differences between the conventional source and the TPS source mainly resides inside the individual sources 312 making up the source 300. FIG. 3 illustrates a cross-section through the source 300, so that only one subarray 302 is visible (which may be any one of the plural subarrays of a typical source). Subarray 302 includes a float 310 from which individual sources (or air-guns) 312 (not all labeled) are suspended with cables or ropes such as 314. For the TPS source, it is possible to have a single individual source 312 per float 310 or per subarray 302. The float 310 is made of a material that floats at the water surface while the individual sources 312 are made to sink. In some locations, such as 316, two or more individual sources may be attached one under another (as illustrated) or parallel, at the same depth. The individual sources may have different volumes (e.g., in a range of 50-350 cm³), and they are fired to combine into a single signal (i.e., pressure wave propagating at sound speed). Some of the individual sources may be turned off, deliberately or due to malfunction.

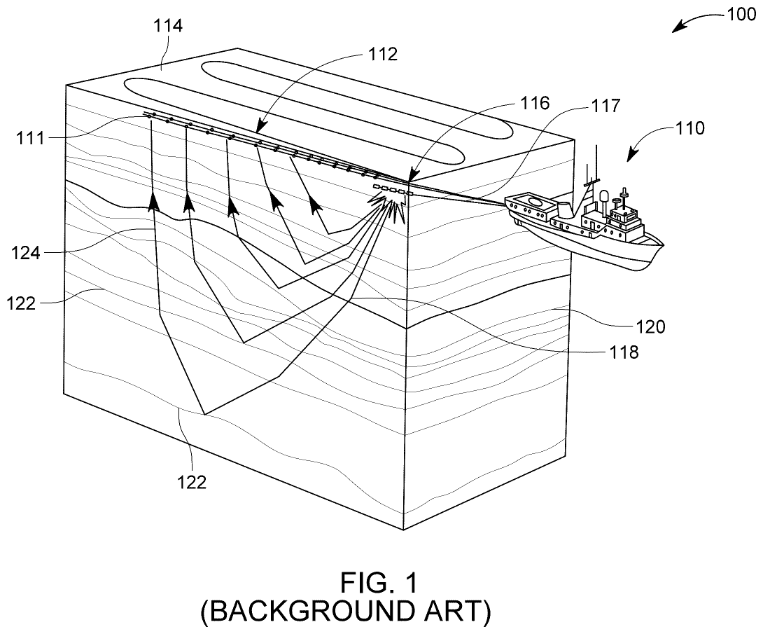

An umbilical 330 connects the subarray 302 to the vessel (not shown, but similar, for example, to vessel 110 in FIG. 1). Umbilical 330 may include cables providing electric power, pipes or hoses providing compressed air, cables providing data transmission, etc. Individual source bases 322 (only some labeled) are connected to each other via links such as 324 and suspended from the float. The electric power, compressed air, and data are distributed to (or collected from) the individual sources via these links. For example, a link 318 supplies the compressed air, and a link 320 provides electric power and/or data transmission to/from individual source 312.

Float 310, cable and ropes such as 314, and the links such as 324 form a support structure for the individual sources 312. A front end 326 of this support structure may be a bell house inside which individual links combine. Front end 326 may also include a bend restrictor to which the float is attached. A longitudinal segment along which the individual sources are attached may be defined by the support structure or as merely a segment between a first and a last individual source aligning in the towing direction.

When individual sources 312 are fired, bubbles they produce coalesce to produce a relatively large broadband signal. Traditionally, the individual sources are optimized (i.e., their volumes, depths, positions along the longitudinal segment, and firing sequence) focusing on the low-frequency (above 1 Hz, e.g., 10-100 Hz) components of this far-field signal, which are more likely to penetrate deep into the explored formation and be detected than the high-frequency components. Lately, the optimization also seeks attenuating very high-frequency (e.g., over 1 kHz) components of signals to avoid disturbing aquatic animals. Such an improved source is the TPS source. Note that the elements illustrated in FIG. 3 extend along the inline direction X. The crossline direction is perpendicular to the inline direction X.

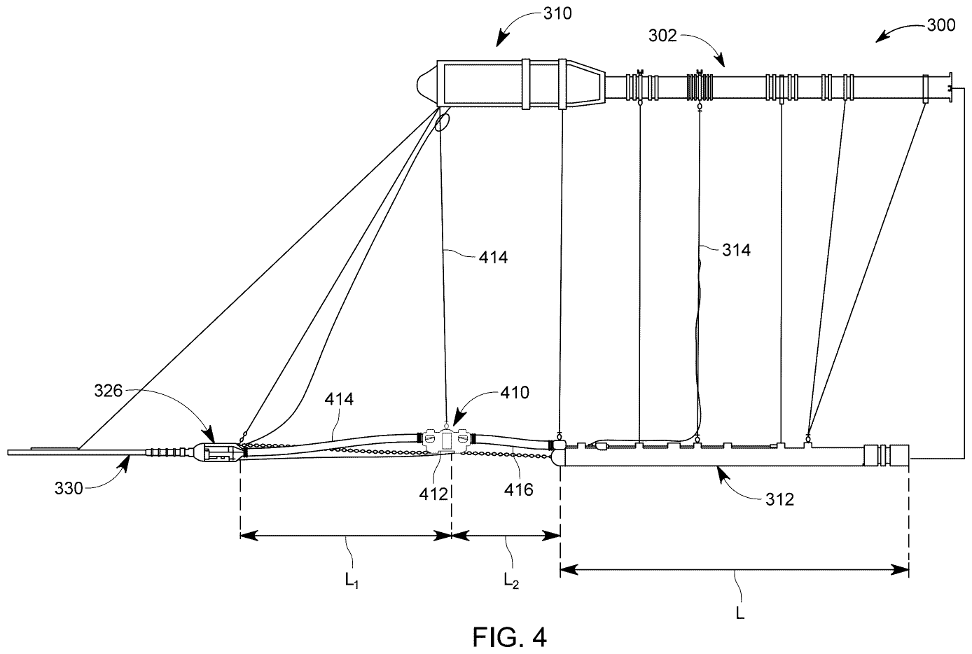

FIG. 4 illustrates a source 300 that has a single individual source 312 (TPS source) per float 310 and includes a pressure regulator 410 positioned downstream from the front end 326 of the umbilical 330, and upstream from the single individual source 312. In one embodiment, the pressure regulator 410 may be attached directly to the float 310. In another and preferred embodiment, the pressure regulator 410 may be attached to a gun plate 412. Either the gun plate 412 or the pressure regulator 410 may be suspended with a link 414 from the float 310. In one embodiment, the link 414 may be attached to the head of the float 310. The link 414 may be a rope or a chain or a band or any other material that has enough strength to support the pressure regulator 410. The pressure regulator 410 may be suspended, in one embodiment, to be at substantially the same depth as the single individual source 312. In this embodiment, the single individual source 312 is long, e.g., has a length L of about 7 to 8 m. The hoses 414 and 416 that connect the pressure regulator 410 to the umbilical 330 and the individual source 310 may have lengths in the meters, e.g., a length L1 of hose 414 is about 4 m and a length L2 of the hose 416 is about 2.5.

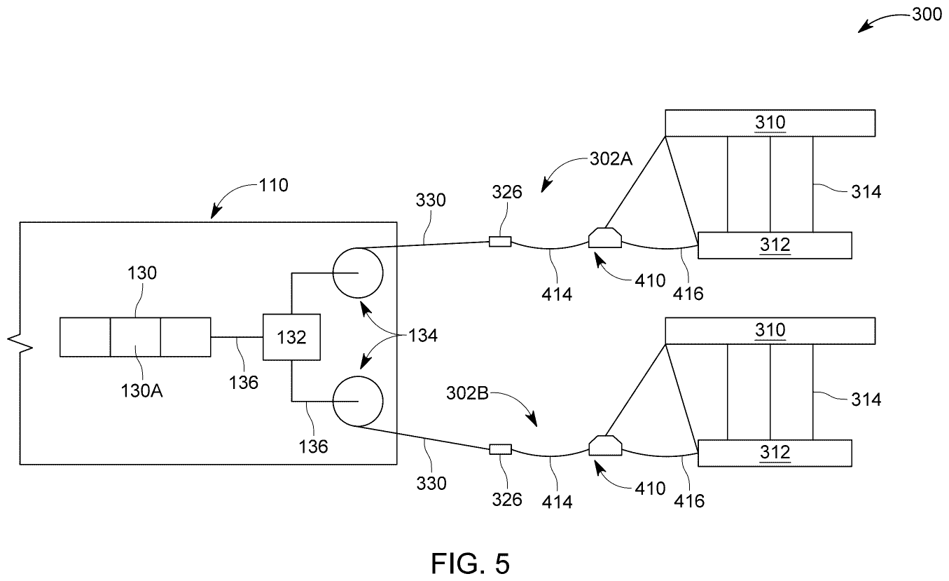

FIG. 5 shows a schematic view of a full source 300 being attached to a towing vessel 110. The towing vessel 110 in the figure has a compressed air supply source 130, which includes one or more compressors 130A. The output of the compressed air supply source 130 is provided to a manifold 132, which distributes the compressed air to each subarray. In this embodiment, the source 300 includes two subarrays 302A and 302B. Each subarray is connected to a corresponding umbilical winch 134, through the umbilical 330. The umbilical winch 134 is configured to roll out and in the corresponding umbilical 330 as necessary. In one embodiment, the umbilical 330 has a length of about 500 m and an interior diameter of about 1 in, i.e., it is a conventional umbilical. However, pipes or hoses 136 fluidly connecting the compressed air supply source 130 to the manifold 132 and the manifold 132 to the umbilicals 330 may have the same or larger internal diameter. FIG. 5 shows that the pressure regulator 410 is fluidly connected with a pipe or hose 414 directly to the front end 326 of the umbilical 330 and with another pipe or hose 416 directly connected to the individual source 312.

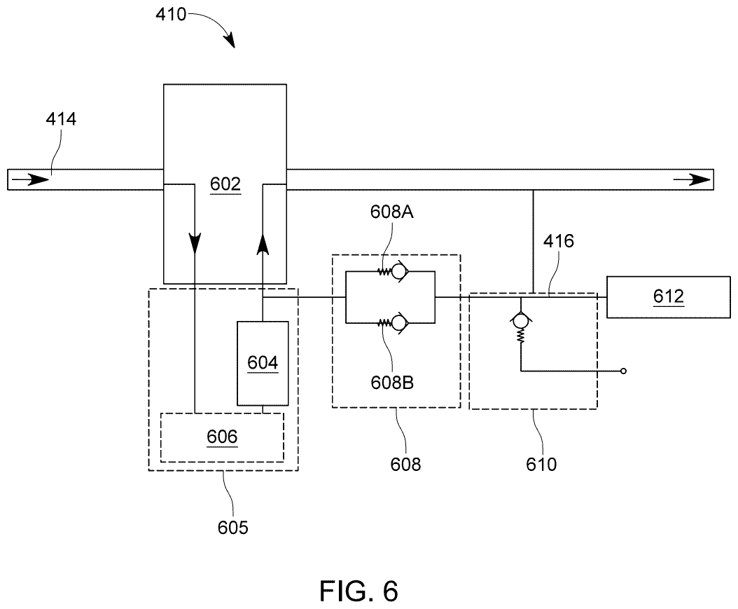

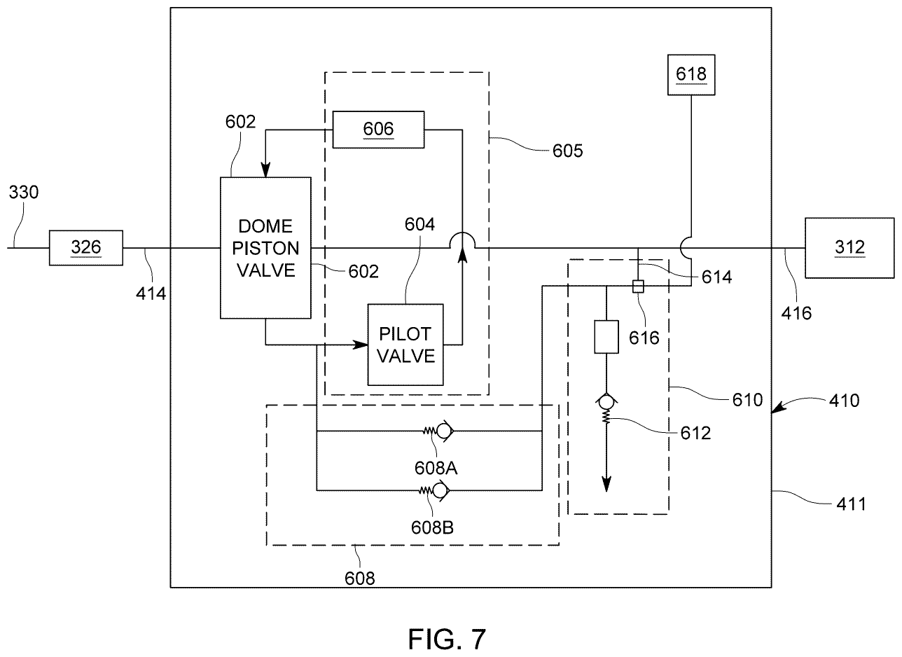

The pressure regulator 410 is schematically illustrated in FIGS. 6 and 7. The pressure regulator 410 is configured to reduce an incoming pressure, from the umbilical, to an output pressure, that is provided to the source. In one embodiment, the incoming pressure is about 2000 psi and the output pressure is about 1000 psi. In one embodiment, the pressure reduction factor is about 1/2. The flow rate through the pressure regulator 410 needs to be high enough to fill the individual sources of the TPS source in the desired time interval. For example, the pressure regulator 410 is configured to pass about 2500 in³ per minute, i.e., it is rated with a flow coefficient Cv>10 (i.e., 10 gallons of water per minute).

The pressure regulator 410 includes a dome piston valve 602, a pilot valve 604, an optional accumulator 606, a check valve block 608, and a safety release valve block 610. As schematically shown in FIG. 7, one or more of these elements are supported by a frame 411, which may be an independent supporting structure or consisting only of a few linking elements. In one embodiment, the frame 411 may define an enclosure that fully encloses these elements. However, the frame 411 may be open so that ambient water moves freely around these elements. In one embodiment, the frame 411 is configured to be directly attached to the gun plate 412, even if a direct attachment to the float 310 is possible. In another embodiment, the frame 411 is the gun plate 412. The hose 414 from the front end 326 of the umbilical 330 is directly connected to the dome piston valve 602. The dome piston valve 602 is fluidly connected to the pilot valve 604 and also fluidly connected to the accumulator 606 if the accumulator 606 is present. In one embodiment, the dome piston valve 602 is directly connected to the pilot valve 604.

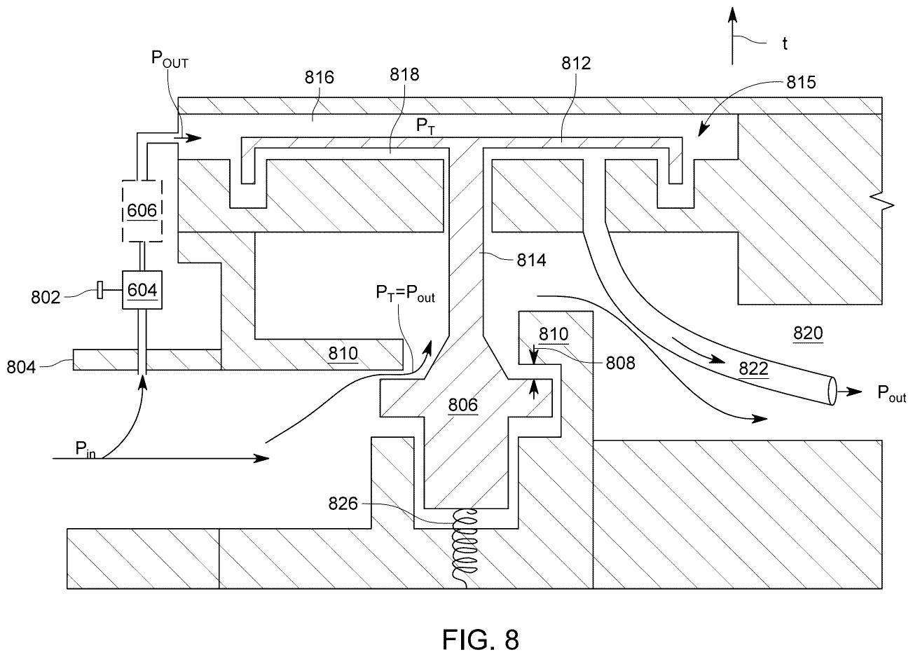

It is noted that the pressure regulator 410 is configured to not release (intentionally) any air in the ambient, as this released air may act as a parasite seismic source, similar to an air gun, and thus contaminates the energy (wavefields) generated by the actual seismic source 300. Because of this strict requirement (feature) of the pressure regulator 410, most of the existing pressure regulators cannot be used in this context as the existing pressure regulators are configured to release some of the compressed air in the ambient. To prevent the release of the compressed air into the water, the pilot valve is specifically chosen to capture this air. The pilot valve 604 may have a mechanism (element 802 in FIG. 8, to be discussed later) for adjusting or selecting the output pressure of the pilot valve, which in turn adjusts the output pressure of the pressure regulator 410. The pilot valve 604 maintains the compressed air pressure at the output of the pressure regulator 410 at the selected level. The pilot valve 604 and the optional accumulator 606 form a pressure block 605.

The check valve pressure block 608 includes one or more check valves 608A and 608B, which are connected in parallel. One end of the check valves is connected at a point between the dome piston valve 602 and the pilot valve 604 as schematically illustrated in FIG. 7. In one embodiment, the check valves 608A and 608B may be replaced by a duckbill valve, flap valve, diaphragm valve, electrical controlled valve or other valve. The check valve pressure block 608 is fluidly connected, with the other end, to the safety release valve block 610, which includes at least a spring ball valve 612 that is connected to the ambient, to release a pressure trapped in the seismic source 300 into the ambient water, before the seismic source is brought onto the vessel. The check valve pressure block 608 and the safety release valve block 610 are configured to allow the seismic source 300 to drain any existing air pressure before being brough on board of the vessel. The check valves 608A and 608B allow for the trapped air inside the source to bypass the dome piston valve 602 and flow back toward the vessel when the inlet pressure is less than the outlet pressure of the source. The safety release valve block 610 is fluidly connected, through link 614, to the pipe or hose 416 that feeds the individual sources 312. A pressure present at the safety release valve block 610 may be measured with a pressure sensor 616, which is electrically connected to a gun firing controller 618. The gun firing controller 618 may include a processor and a memory.

FIG. 8 illustrates one possible implementation of the dome piston valve 602, the pilot valve 604, and the optional accumulator 606. The pilot valve 604 has a mechanism 802 for adjusting a pressure output of the pilot valve. For example, the mechanism 802 may include a spring, a ball, and a motor or hand adjusted lever, which increases or decreases the pressure applied by the spring to a ball. If a motor is used, the motor may be remotely controlled from a general controller located on the vessel. In this way, the operator of the pressure regulator 410 may adjust the target pressure Pt of the pilot valve 604, which implicitly adjusts the output pressure of the dome piston valve 602. FIG. 8 shows the input pressure Pin (pressure from the manifold from the vessel) being supplied to an input port 804 of the dome piston valve 602. The input pressure is split between the pilot valve 604 and the dome piston valve 602. A piston 806 of the dome piston valve 602 is configured to regulate the output pressure Pout at the dome piston valve 602.

For example, if the piston 806 moves in an upward direction, along axis Z in FIG. 8, it reduces a space between the piston 806 and a shoulder 810 of the valve 602, thus reducing the output pressure Pout. When the piston 806 moves opposite to axis Z, the space between piston 806 and the shoulder 810 is increased, thus increasing in the output pressure Pout. The movement of the piston 806 tracks a movement of a piston 812, due to a connection rod 814 that connects the piston 812 to the piston 806. The piston 812 separates an interior chamber 815, of the dome piston valve 602, into a first chamber 816 and a second chamber 818. A pressure in the first chamber 816 is determined by the output pressure (target pressure) Pt of the pilot valve 604. A pressure in the second chamber 818 is determined by the output pressure Pout of the fluid passing the piston 806 as the second chamber 818 fluidly communicates with the output port 820 of the dome piston valve 602, through a channel 822. Thus, if the output pressure Pout becomes smaller than the target pressure Pt, the piston 812 is deviated in a downward direction, increasing the space 808 between the piston 806 and the shoulder 810, thus allowing more input compressed air passing through the valve 602. If the output pressure Pout becomes larger than the target pressure Pt, the piston 812 is deviated in an upward direction, decreasing the space 808 between the piston 806 and the shoulder 810, thus allowing less input compressed air passing through the valve 602. This means that the output pressure Pout tracks the target pressure Pt set up by the pilot valve 604.

As previously discussed, the pressure regulator 410 is configured to have the target pressure Pt smaller than the input pressure Pin, for example, Pt=Pout=1000 psi and Pin=2000 psi. Other values may be used depending on the parameters of the seismic source. FIG. 8 also shows a biasing spring 826 that biases the piston 806 along the positive direction of the Z axis, i.e., to close the space between the piston 806 and the shoulder 810. In one embodiment, the mechanism 802 may include a motor, which is electrically actuated to adjust the target pressure Pt as desired.

The pressure regulator 410 ensures that after the refill stage of the seismic source, the pressure inside the umbilical is maintained at the input pressure Pin, e.g., 2000 psi in the embodiment discussed above. Thus, as soon as the seismic source is fired, and it needs to be replenished with compressed air, by opening the pressure regulator 410, compressed air is immediately pumped into the seismic source. As the pressure regulator 410 is configured to allow a large air flow through it, the seismic source is quickly refilled with the required compressed air.

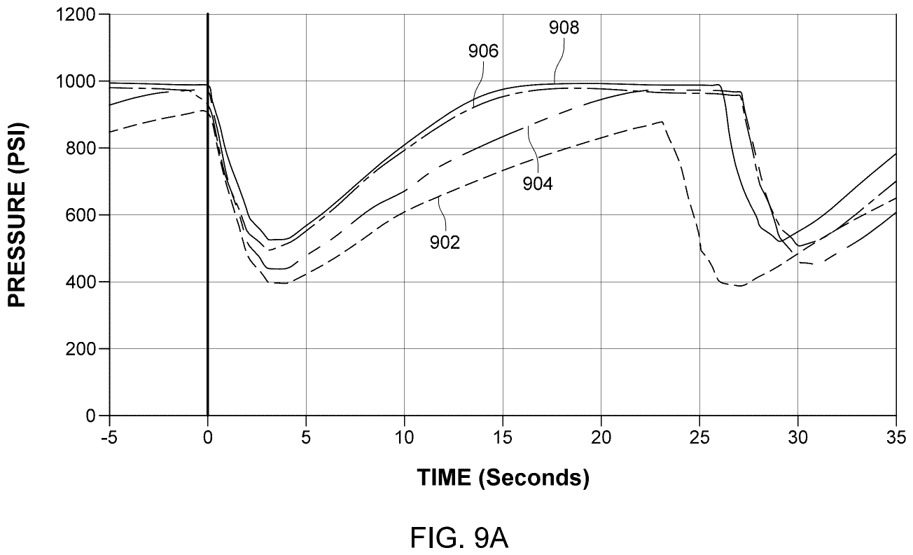

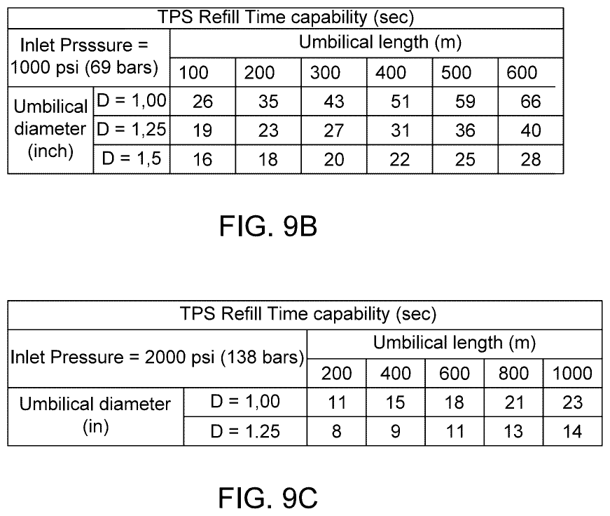

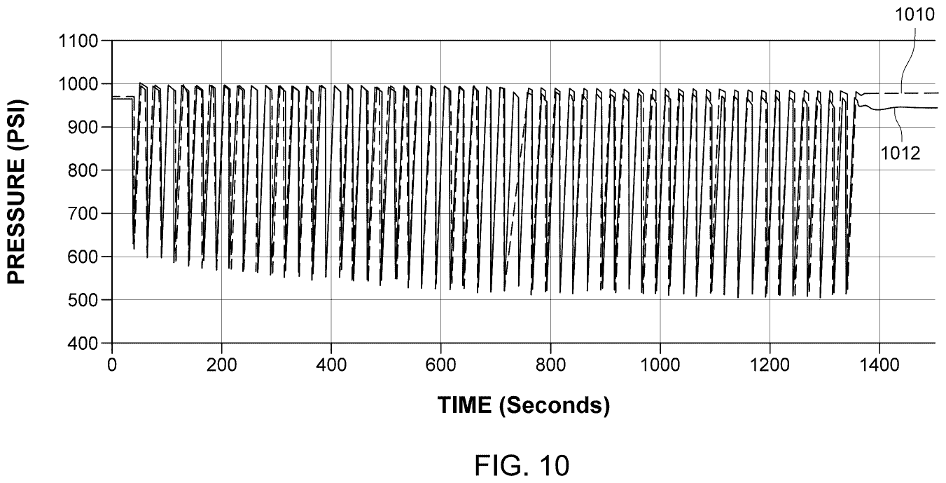

FIG. 9A illustrates various scenarios (different umbilical lengths and inner diameters) for filling the seismic source with the compressed air. More specifically, FIG. 9A shows the TPS source fill time for various pressures, e.g., 1060 psi for curve 902, 1250 psi for curve 904, 1500 psi for curve 906, and 1800 psi for curve 908. FIG. 9A shows the pressure inside the TPS source on the Y axis versus the filling time on the X axis. FIG. 9B shows the refill time for the sources without the pressure regulator 410, for various umbilical lengths and umbilical diameters, for an inlet pressure of about 1000 psi while FIG. 9C shows the refill time for a seismic source with the pressure regulator 410, for an inlet pressure of about 2000 psi. It is noted that for a same umbilical length and a same umbilical diameter, the refill time is much shorter when the pressure regulator 410 is used. For example, for an umbilical inner diameter of 1 in and a length of 600 m, the filling time is about 66 s (in FIG. 9B) when no pressure regulator is used compared to a filling time of 18 s (in FIG. 9C) when the pressure regulator 410 is used for a TPS source. The reduced filling time allows the TPS source to perform denser shots. Also, because of the pressure regulator 410, it is possible to increase the input pressure beyond 2000 psi as the pressure regulator is configured to reduce the pressure supplied to the TPS source to about 1000 psi. Note that the current compressors have to supply the compressed air at a pressure not larger than 2000 psi as the current air guns are rated for this value. However, because the pressure regulator 410 automatically reduces the incoming pressure to about 1000 psi, the input pressure of 2000 psi may be exceeded without any safety concern. This in turn allows the umbilical to be pressurized to a high pressure and to supply a large flow of compressed air to the TPS source. FIG. 10 illustrates the pressure supplied by the pressure regulator 410 to the seismic source versus time, for a first sub-array (curve 1010) and a second subarray (curve 1012) of a same seismic source 300.

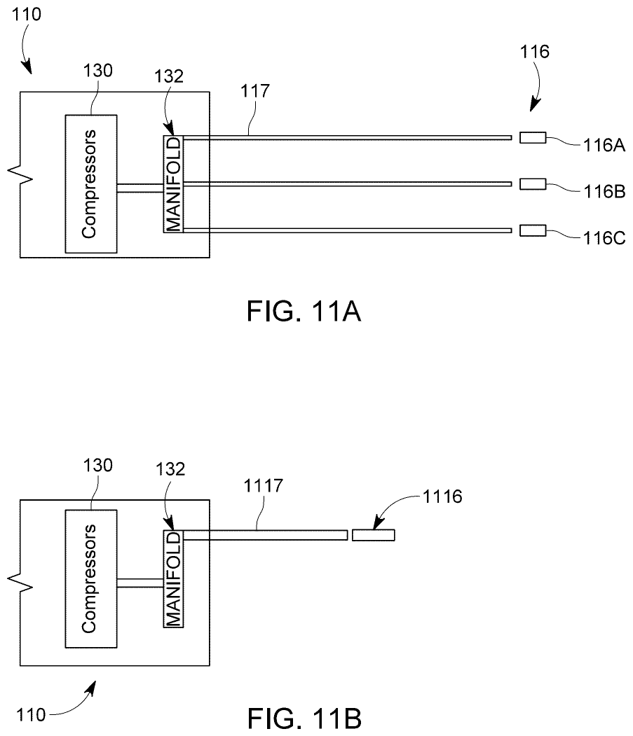

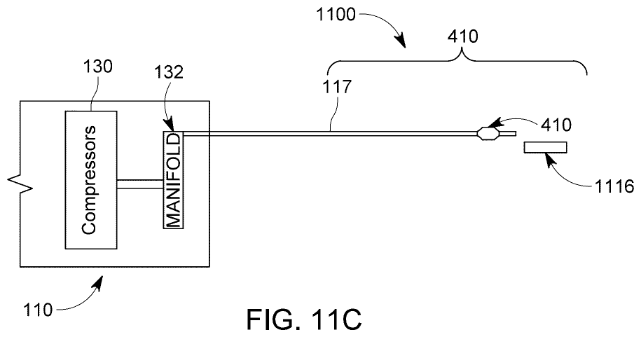

As discussed above, by implementing the pressure regulator 410 downstream from the front end 326 of the umbilical 330, and upstream from the seismic source 300, it is possible to use the same umbilical for a TPS source and a conventional source. In this regard, FIG. 11A shows a seismic survey in which a conventional seismic source 116, including three subarrays 116A to 116C, is towed by the vessel 110. The compressor 130 pumps compressed air to the manifold 132, which distributes the compressed air to each subarray 116A to 116C, through a corresponding conventional umbilical 117. The conventional umbilical 117 may have a length of about 500 m and an internal diameter of about 1 in for the hose transporting the compressed air.

FIG. 11B shows a seismic survey in which a TPS source 1116 is used. Due to the large volume of the TPS source 1116, a TPS-specific umbilical 1117 is currently used, and this specific umbilical is shorter, about 200 m, and has a larger inner diameter, about 1 and ¼ in, than the conventional umbilical 117. Even with this specific umbilical, the TPS source 1116 might not be refilled as fast as a conventional source 116.

FIG. 11C shows that when the pressure regulator 410 is used, a conventional umbilical 117 (which may be the same as the umbilical 330 in FIGS. 3 and 4) may be used with the TPS source 1116. In this way, the towing vessel 110 does not need to carry different types of umbilicals for the different sources. Also, the TPS source 1116 may be filled as fast as a conventional source 116 when the pressure regulator 410 is used. The umbilical 117 (or 330), the pressure regulator 410, and the TPS source 1116 are part and constitute the seismic survey system 1100. The system 1100 is configured to generate seismic waves underwater.

Due to the pressure regulator 410, the system 1100 may use increased compressor pressure and umbilical pressure, above a maximum allowable pressure of the seismic source, as the pressure regulator 410 is configured to reduce the pressure supplied to the seismic source. In other words, the safety associated with the seismic source is transferred from the compressor, for a conventional seismic survey system 100, to the pressure regulator 410, for the improved seismic survey system 1100. The refilling process (time) is improved due to the increased pressure while the pressure regulator 410 keeps the TPS source 1116 safe from overpressure risks. This means that there is less room for human errors for the system 1100, although it may work at a higher pressure, as the pressure regulator does not allow to overpressure the source. In addition, by controlling the pressure of the compressed air supplied to the source, the pressure regulator 410 reduces the need for the safety release valve, that wastes energy.

In one embodiment, the use of the pressure regulator provides a geophysical advantage as it reduces the need for the safety release valve, which generates noise, i.e., pollution of the seismic signal. Another geophysical advantage maybe be related to a stable signature of the source with the same pressure for all shots. In one embodiment, active control of the pressure regulator may be implemented so that the operator of the vessel may remotely adjust one or more parameters of the source to be aligned with specific algorithms (pressure related to depth, NFH signal, etc.) for signature output stabilization.

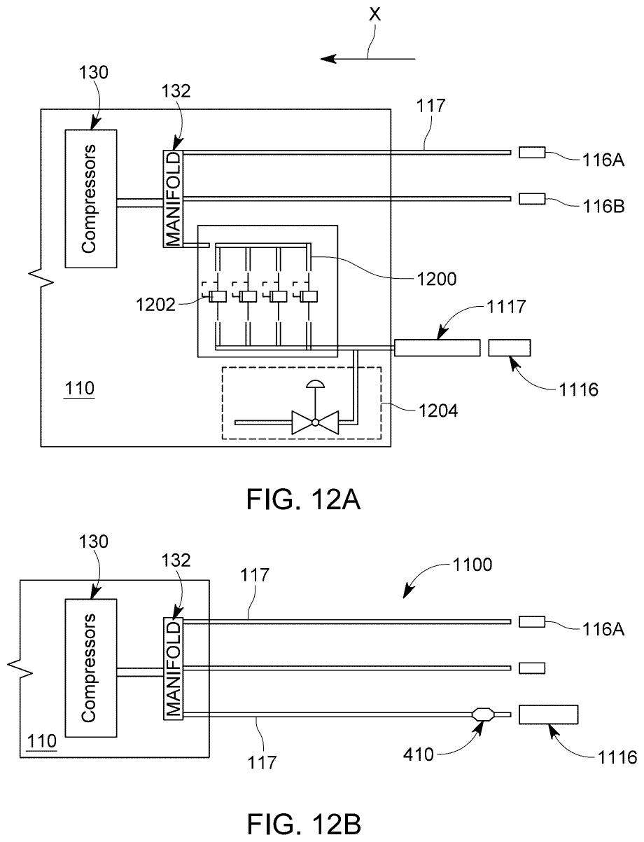

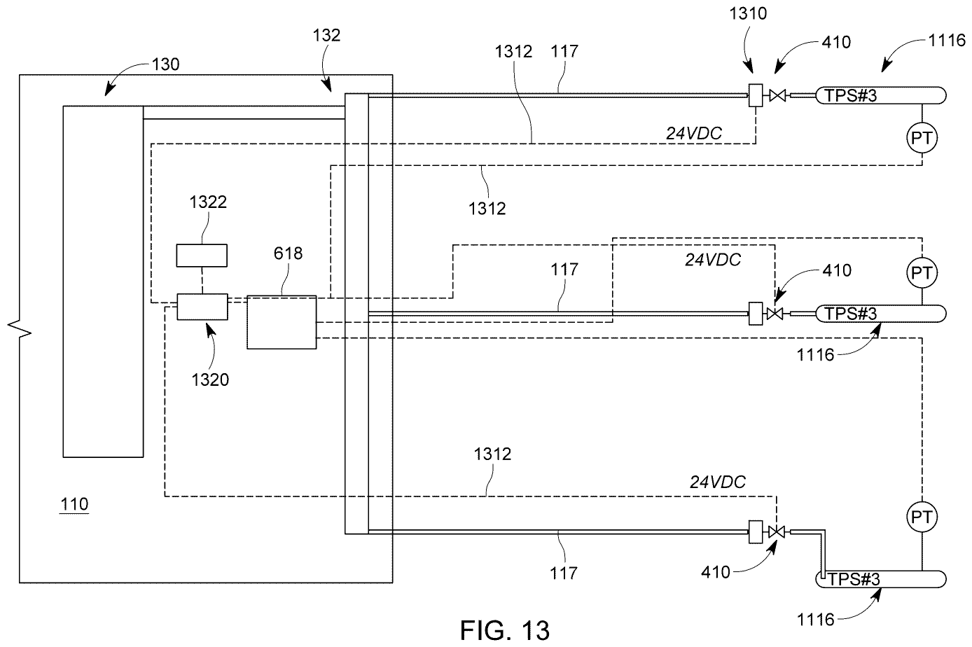

In one embodiment, as illustrated in FIG. 12A, a hybrid survey is performed, which means that a conventional source 116 and a TPS source 1116 are simultaneously towed by the same vessel 110 and both sources are used for generating the seismic waves. For this case, the vessel tows two different umbilicals, one umbilical 117 for the conventional seismic source 116 and a different umbilical 1117 for the TPS source 1116. In this embodiment, the seismic source 116 is rated for 2000 psi while the TPS is rated for 1000 psi. As the manifold 132 is charged at 2000 psi, a bank 1200 of pressure regulators 1202 is placed on the deck of the vessel 110 for reducing the input pressure of 2000 psi to about 1450 psi and this reduced pressure is provided to the TPS-specific umbilical 1117 (which is shorter and thicker than umbilical 117). Due to these requirements, the TPS source 1116 is ahead of the conventional seismic source 116, along the inline direction X, as illustrated in FIG. 12A. A control valve 1204 needs to also be placed on the deck of the vessel 110 as a safety, to allow any pressure that is above a given pressure at the TPS source 1116 to escape.

However, when the pressure regulator 410 is used underwater, between the umbilical 117 and TPS source 1116, as illustrated in FIG. 12B, all sources are at the same distance relative to the towing vessel 110 along the inline direction X, there is no need for the bank 1200 of the pressure regulators on the deck of the vessel, and there is no control valve 1204 for the safety on the source. This last function is present at the pressure regulator 410, as discussed above with regard to FIG. 4. The umbilicals 117 (or 330), the conventional source 116, the pressure regulator 410, and the TPS source 1116 constitute the system 1100 in this embodiment.

The pressure regulator 410 has been selected and configured to not release air into the water as the released air may contaminate the source's signature. However, in one embodiment, it is possible to use a pressure regulator that releases air in the ambient, but the pressure regulator is provided with a hose or pipe (not shown) that directs the unwanted released air to the surface of the water rather than into the water, thus preventing the noise. Alternatively, the frame of the pressure regulator can be associated with the float for direct air emission in the atmosphere.

In one embodiment, the safety release valve block 610 may be replaced with an electro-mechanical safety device that releases the source (gun) pressure in the event the umbilical becomes kinked or damaged. Communication with the electro-mechanical safety device may be achieved via an acoustic modem which actuates a valve or energizes a burn-wire resulting in the release of the pressure contained in the gun chamber.

In yet another embodiment, as schematically illustrated in FIG. 13, an electro-mechanical device 1310 (this is one possible implementation of mechanism 802 shown in FIG. 8) that may include, for example, at least a gear motor, solenoid valve, and local controller, may be used with the pilot valve 604 of the pressure regulator 410 to dynamically control the output pressure of the pressure regulator. The electro-mechanical device 1310 may be electrically controlled through corresponding wires 1312, by a global controller 1320 located on the vessel 110. The global controller 1320 may be connected to a display 1322 for displaying various parameters associated with the seismic survey, for example, the pressure at the sources. The global controller may use, in one embodiment, a pulsed DC current of about 2 to 5 kHz for controlling the electro-mechanical device 1310. In one embodiment, the global controller 1320 may be used to adjust the pressure regulator 410's outlet pressure (up or down) or simply to isolate the source from the umbilical. While FIG. 13 shows the communication between the global controller and the pressure regulator to be electromagnetically implemented, it is also possible to use acoustic modems, at the vessel and at the source, or superimposing a data signal onto the existing power line by phase-shift-keying, or by wireless connection (for example, having an antenna on the float 310). FIG. 13 also shows the source controller 618, which is configured to fire the source elements. The source controller 618 may be in communication with the global controller for controlling the output pressure of the sources. A feedback loop might be implemented so that the operator of the vessel may dynamically change the output pressure of the pressure regulator 410, for the TPS source 1116 as required by the subsurface topology. For example, the global controller 1320 may receive a reading from a seismic sensor located on or near the TPS source, and based on this reading, the global controller may adjust the output of the source by controlling in real time the pressure output of the pressure regulator 410.

In one embodiment, the pressure regulator 410 may be replaced with a valve (co-axial or other model) that isolate the source from the compressor's input when the source pressure reaches a desired shooting pressure. Active control of the pressure setting may be achieved onboard the vessel 110 or at sea.

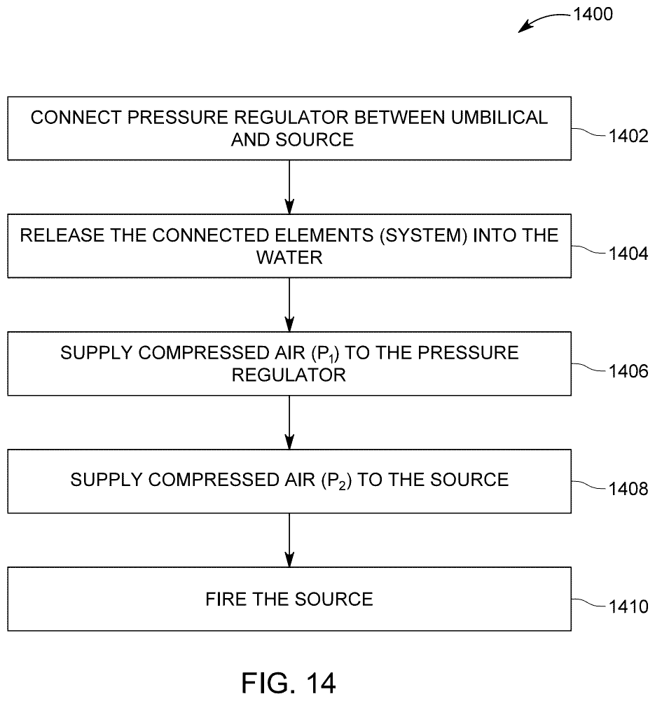

A method for deploying a seismic source is now discussed with regard to FIG. 14. The method 1400 includes a step 1402 of connecting a pressure regulator 410, between a first umbilical 330 and a first seismic source 300, a step 1404 of releasing the assembled first umbilical 330, pressure regulator 410, and the first seismic source 300 (i.e., system 1100) into the water, a step 1406 of supplying compressed air at a given first pressure P1, from the vessel 110, to the first umbilical 330 and a pressure regulator 410, a step 1408 of supplying compressed air at a given second pressure P2, smaller than the first pressure, from the pressure regulator 410 to the first seismic source 300, and a step 1410 of firing the first seismic source 300 to generate seismic waves underwater. In one embodiment, the first umbilical is a conventional umbilical, for example, having a length of about 500 m and an internal diameter of about 1 in. In another embodiment, the first pressure is about 2,000 psi and the second pressure is about 1,000 psi. In yet another embodiment, the second pressure is about half the first pressure. In one embodiment, the first seismic source includes a conventional seismic source 116 and a TPS source 1116, and each source is towed by a corresponding umbilical. In this embodiment, the first umbilical of the conventional seismic source has the same characteristics (e.g., length, internal diameter, etc.) as the umbilical of the TPS source. In one embodiment, a same vessel tows a second seismic source, the second seismic source being directly coupled to a second umbilical, which has a same length and internal diameter as the first umbilical. A volume of the first seismic source is at least 10 times larger than a volume of the second seismic source.

The methods discussed herein may be applied not only to the field of subsurface exploration, for example, hydrocarbon exploration and development, but also to the fields of geothermal exploration and development, and carbon capture and sequestration, or other natural resource exploration and exploitation. They could also be employed for surveying and monitoring for windfarm applications, both onshore and offshore.

The terms “about” and “substantially” when used in this application mean a variation of up to 20% of the parameter characterized by these terms.

It will be understood that, although the terms first, second, etc. may be used herein to describe various elements, these elements should not be limited by these terms. These terms are only used to distinguish one element from another. For example, a first object or step could be termed a second object or step, and, similarly, a second object or step could be termed a first object or step, without departing from the scope of the present disclosure. The first object or step, and the second object or step, are both, objects or steps, respectively, but they are not to be considered the same object or step.

The terminology used in the description herein is for the purpose of describing particular embodiments and is not intended to be limiting. As used in this description and the appended claims, the singular forms “a,” “an” and “the” are intended to include the plural forms as well, unless the context clearly indicates otherwise. It will also be understood that the term “and/or” as used herein refers to and encompasses any possible combinations of one or more of the associated listed items. It will be further understood that the terms “includes,” “including,” “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Further, as used herein, the term “if” may be construed to mean “when” or “upon” or “in response to determining” or “in response to detecting,” depending on the context.

The disclosed embodiments provide marine sources, umbilicals, and pressure regulators and associated methods for achieving a faster refilling of a large volume seismic source. It should be understood that this description is not intended to limit the invention. On the contrary, the exemplary embodiments are intended to cover alternatives, modifications and equivalents, which are included in the spirit and scope of the invention as defined by the appended claims. Further, in the detailed description of the exemplary embodiments, numerous specific details are set forth in order to provide a comprehensive understanding of the claimed invention. However, one skilled in the art would understand that various embodiments may be practiced without such specific details.

Although the features and elements of the present exemplary embodiments are described in the embodiments in particular combinations, each feature or element can be used alone without the other features and elements of the embodiments or in various combinations with or without other features and elements disclosed herein.

This written description uses examples of the subject matter disclosed to enable any person skilled in the art to practice the same, including making and using any devices or systems and performing any incorporated methods. The patentable scope of the subject matter is defined by the claims, and may include other examples that occur to those skilled in the art. Such other examples are intended to be within the scope of the claims.

What is claimed is:

1. A pressure regulator for controlling a pressure supplied by an umbilical to a seismic source, the pressure regulator comprising:
a frame configured to be located downstream from the umbilical and upstream from the seismic source;
a dome piston valve supported by the frame and configured to receive compressed air with an input pressure Pin and to output compressed air with an output pressure Pout, smaller than the input pressure Pin; and
a pilot valve supported by the frame and configured to control the output pressure Pout,
wherein the pilot valve and the dome piston valve are configured to prevent a release of the compressed air into the ambient.

2. The pressure regulator of claim 1, wherein the pilot valve comprises a mechanism for adjusting the output pressure.

3. The pressure regulator of claim 1, wherein the pressure regulator is configured to be attached directly to a gun plate when underwater.

4. The pressure regulator of claim 1, wherein the dome piston valve comprises a piston that divides an interior chamber into a first chamber and a second chamber, the first chamber is fluidly connected to the pilot valve and the second chamber is fluidly connected to an output port of the dome piston valve.

5. The pressure regulator of claim 1, wherein the pilot valve is configured to output a target pressure Pt, less than the input pressure Pi, and the target pressure Pt is substantially equal to the output pressure Pout.

6. A seismic survey system for generating seismic data underwater, the system comprising:
a first umbilical configured to be connected with a first end to a manifold on a vessel and with a second end to a pressure regulator;
the pressure regulator configured to be connected downstream from the first umbilical and upstream from a first seismic source, the pressure regulator being configured to receive compressed air having an input pressure Pin and to output compressed air having an output pressure Pout, smaller than the input pressure Pin; and
the first seismic source configured to generate seismic waves underwater.

7. The system of claim 6, wherein the pressure regulator and the first seismic source are configured to operate fully underwater when towed by a vessel.

8. The system of claim 6, further comprising:
a second umbilical and a second seismic source.

9. The system of claim 8, wherein the first seismic source has a volume for receiving the compressed air larger than a volume of the second seismic source.

10. The system of claim 8, wherein the first umbilical is substantially identical to the second umbilical.

11. The system of claim 8, wherein the second umbilical is directly attached to the second seismic source.

12. The system of claim 6, wherein the pressure regulator is configured to receive the compressed air from the first umbilical, at a pressure higher than a safety pressure limit of the first source.

13. The system of claim 6, wherein the pressure regulator comprises:
a frame;
a dome piston valve supported by the frame and configured to receive the input pressure Pin and to output the output pressure Pout, smaller than the input pressure Pin; and
a pilot valve supported by the frame and configured to control the output pressure Pout and to prevent a release of the compressed air into the ambient.

14. The system of claim 13, wherein the pilot valve comprises a mechanism for adjusting the output pressure.

15. The system of claim 13, further comprising:
a controller configured to control the pressure regulator to adjust the output pressure Pout.

16. The system of claim 13, wherein the dome piston valve comprises a piston that divides an interior chamber into a first chamber and a second chamber, the first chamber is fluidly connected to the pilot valve and the second chamber is fluidly connected to an output port of the dome piston valve.

17. The system of claim 13, wherein the pilot valve is configured to output a target pressure Pt, less than the input pressure Pi, and the target pressure Pt is substantially equal to the output pressure Pout.

18. A method for generating seismic data with a first marine seismic source, the method comprising:
connecting a pressure regulator between a first umbilical and the first seismic source;
deploying the first umbilical, pressure regulator, and the first seismic source in water;
supplying compressed air having an input pressure, through the first umbilical, to the pressure regulator;
supplying compressed air having an output pressure, smaller than the input pressure, from the pressure regulator to the first seismic source; and
firing the first seismic source to discharge the compressed air having the output pressure into the water.

19. The method of claim 18, further comprising:
towing a second seismic source, wherein the second seismic source is directly coupled to a second umbilical, which has substantially a same length and internal diameter as the first umbilical.

20. The method of claim 19, further comprising:
adjusting the output pressure of the pressure regulator from a towing vessel while the pressure regular is deployed underwater.
